(19) United States
(12) Patent Application Publication
(10) Pub. No.: US 2008/0117839 A1
(43) Pub. Date: May 22, 2008

(54) METHOD AND SYSTEM FOR MANAGING INTEGRATED MEDIA GROUP COMMUNICATIONS

(75) Inventors: Vishwanath RAJU, Ottawa (CA); Deborah L. PINARD, Dunrobin (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, omitted

(73) Assignee: FIRSTHAND TECHNOLOGIES INC., Ottawa (CA)

(21) Appl. No.: 11/560,526

(22) Filed: Nov. 16, 2006

(51) Int. Cl. H04L 12/18

(52) U.S. Cl. 370/261

(57) ABSTRACT

A method and system for enabling and managing multimedia group communications, particularly for mobile devices attached to a Session Initiation Protocol (SIP)-enabled network. The method and system provide a plug-and-play architecture for managing policy-based group communications. The method and system provide standardized set up and delivery of services, and can integrate different media types. Groups can be created on an ad hoc basis, and group services can be extended to mobile communication devices, such as cellular telephones. A single server architecture permits policies, such as group presence policies, to be implemented.

### FIELD OF THE INVENTION

The present invention relates generally to group communications. More particularly, the present invention relates to integrated media group communications using Session Initiation Protocol (SIP).

### BACKGROUND OF THE INVENTION

In order to contain costs and extend functionality, enterprises are eager to adopt Voice over IP (VoIP) and other Internet Protocol (IP)-based communication services. To address this need, developers of Private Branch Exchange (PBX) equipment and software have developed IP PBXs to provide the functionality users expect in conventional PBXs, such as conference calling, call forwarding, automatic call distribution, shared message boxes, etc., and to provide new functionality that takes advantage of the multimedia content that can be transmitted over the Internet.

Session Initiation Protocol (SIP), specified in the RFC 3261 of the Internet Engineering Task Force (IETF) SIP Working Group, is an application-layer control (signaling) protocol for creating, modifying, and terminating sessions with one or more participants, and is widely used as a signaling protocol for VoIP. SIP sessions can be of different media types, including Internet Protocol (IP) telephone calls, instant messaging (IM), multimedia distribution, and multimedia conferences. SIP provides a signaling and call setup protocol for IP-based communications that can support many of the call processing functions and features present in the public switched telephone network (PSTN). SIP itself does not define these features. However, SIP permits such features to be built into network elements, such as proxy servers and user agents, and implementing these features permits familiar telephone-like operations, such as dialing a number, causing a phone to ring, and hearing ringback tones or a busy signal.

SIP works in concert with several other protocols and is only involved in the signaling portion of a communication session. SIP acts as a carrier for the Session Description Protocol (SDP), which describes the set up and media content of the session, such as the IP ports to use and the codec being used. SIP clients typically use Transmission Control Protocol (TCP) and User Datagram Protocol (UDP) to connect to SIP servers and other SIP endpoints. SIP is most commonly used to set up and tear down voice and video calls. However, it can be used in any application where session management is a requirement, such as event subscription and notification, and terminal mobility. All communications are done over separate session protocols, typically implementing Real-Time Transport Protocol (RTP).

SIP-enabled telephony networks can also implement many of the more advanced call processing features present in Signaling System 7 (SS7). However, while SS7 is a highly centralized protocol, characterized by complex central network architecture and unintelligent endpoints (conventional telephone handsets), SIP is a peer-to-peer protocol. SIP features are typically implemented in the communicating endpoints (i.e. at the edge of the network) as opposed to traditional SS7 features, which are implemented in the network.

Since SIP is a peer-to-peer protocol, it does not inherently support groups or group communications. Current IP PBXs typically require pre-programmed groups. Ad-hoc conferences can be created, but conferees have to added one at a time. As well, Instant Messaging (IM), video, conferencing, fax and email are handled by different systems which all have their own groups, features, rules and application programming interfaces (APIs).

Enterprises, and their employees, also increasingly rely on mobile communication devices, such as cellular telephones and wireless messaging devices, to carry out day-to-day business. Currently, there is no integration between cellular and SIP-based services, such as VoIP. Thus, mobile device users do not have access to the rich IP-enabled features and services, nor do they, typically, have access to the features and services offered by the PBX associated with their enterprise.

It is, therefore, desirable to provide a method and system that provides unified group functionality to SIP-enabled devices. It is also desirable to provide a method and system that extends such group functionality to mobile communication devices.

### SUMMARY OF THE INVENTION

In a first aspect, the present invention provides a method of managing a multimedia group communication. The method comprises receiving a group communication request including a group communication type, at least one media type and a group determiner. Group members associated with the group communication request are then determined, and a group session, including the determined group members and at least one media type, is created. The group communication request can be received from a client device, such as a wireless mobile communications device, a SIP device, or a personal computer. The wireless mobile communications device can be, for example, a Class A cellular telephone, a Class B cellular telephone, a dual mode WiFi/Cellular device, or a WiFi only device. The group communication request can be an externally triggered request, such as an alarm that invokes a policy. The group communication request can include a pre-programmed message. The at least one media type can be, for example, voice, video, instant messaging (IM), facsimile or email, and conversations can occur over multiple media types, sequentially or concurrently.

According to embodiments of this aspect, the method can further include passing the group session to a media server to invoke the group communication. The group communication type can be, for example, a conference communication or a serial communication. The group determiner can be an identification of a pre-programmed group, a user selection, a user attribute, a policy or a previously determined group. Where the group determiner is a policy, the group members associated with the group communication request can be determined by invoking the policy. User attributes can be, for example, presence, proximity, subscription to a topic, or availability. Presence can be a role-based presence. Group members can be determined by filtering on the user attribute.

In a further aspect, there is provided a multimedia server for managing a group communication. The server comprises an intelligent client side agent to establish and manage the group communication; and an intelligent server side agent having a group manager to receive a group communication request, to determine group members associated with the group communication request, and to create group sessions for the group communication, the group sessions including the group members and at least one media type. The intelligent client side agent can include a convergence services session manager, and the intelligent server side agent can include a back-to-back (B2B) user agent to set up the group sessions under the control of the convergence services session manager.

The method and system of the present invention permit group communicatoins to be efficiently managed, and permit a rich feature set, pertaining to the group communication, to be offered to users. Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 shows an exemplary system architecture according to an embodiment of the present invention;

FIG. 2 is a block diagram of a integrated media group communications server according to an embodiment of the present invention;

FIG. 3 is a block diagram of a group manager according to an embodiment of the present invention; and

FIG. 4 is a flow chart of a method of group management according to an embodiment of the present invention.

### DETAILED DESCRIPTION

Generally, the present invention provides a method and system for enabling and managing multimedia group communications, particularly for mobile devices attached to a Session Initiation Protocol (SIP)-enabled network. The method and system provide a plug-and-play architecture for managing policy-based group communications. The method and system provide standardized set up and delivery of services, and can integrate different media types. Groups can be created on an ad hoc basis, and group services can be extended to mobile communication devices, such as cellular telephones. The present invention also permits policies, such as group presence policies, to be implemented.

An adjunct multimedia server is provided for managing group communications using different media types. The adjunct server architecture permits on-the-fly or pre-programmed group creation, as well as the integration of media types, into a seamless environment, to provide a consistent end-user experience. A user can create or select a group, select a desired media type, and select a desired communication format. The user can choose to invoke the communication immediately, or at a later convenient time. The system can also choose to initiate a group communication on its own based on system triggers, such as alarm status. The system manages this in such a way that new media and communication types can be easily added, as can new policies for invoking them.

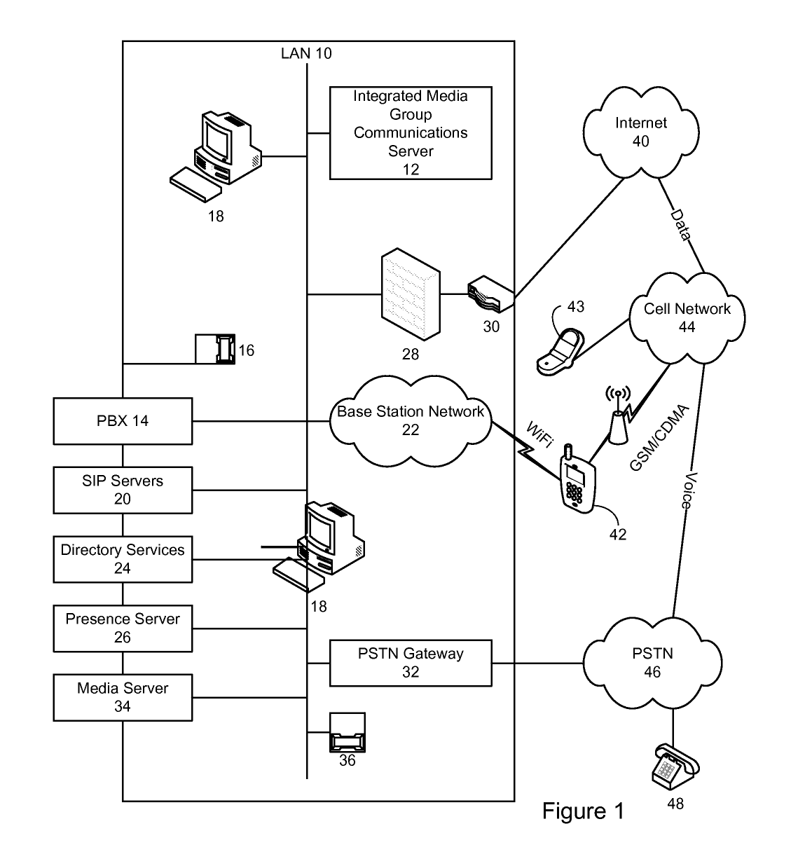

Referring to FIG. 1, a SIP enterprise system architecture according to an embodiment of the present invention, with connections to public networks, is shown. The system architecture is intended to be exemplary only, and the actual system architecture will depend on the services and functionality desired by the enterprise. Typically, the system hardware will be housed in a single building, but distributed architectures are equally contemplated and encompassed by the present invention. The illustrated enterprise hardware comprises a Local Area Network (LAN) 10 to which is connected an integrated media group communications server 12, an Internet Protocol Private Branch Exchange (IP PBX) 14, telephones 16, workstations 18 which may optionally be running SIP softphones, SIP servers 20, a base station network 22, a directory services server 24, a presence server 26, a firewall 28 and router 30, a Public Switched Telephone Network (PSTN) gateway 32, a media server 34, and SIP telephones 36. While shown as separate and distinct devices, the various components of the enterprise system can be integrated in many ways, as is well known in the art. For example two or more of the server functions can be integrated into a single device, or can be integrated into the PBX 14.

The PBX 14 is connected to the SIP servers 20 over LAN 10, and communicates with the SIP servers using SIP. SIP servers are proxy servers that route requests to the user's current location, authenticate and authorize users for services, implement provider call-routing policies, and provide features to users. SIP also provides a registration function that allows users to upload their current locations for use by proxy servers. The PBX 14 is connected to telephones 16 via conventional circuit-switched connections. The PBX 14 can be connected to the PSTN via the PSTN gateway 32 as shown, or it can be directly connected. The SIP servers 20 are connected to the SIP telephones 36 and the PSTN gateway 32 via the LAN 10. The PSTN gateway 32 translates SIP into various PSTN protocols, as is well known.

The integrated media group communications server 12 communicates with the SIP servers 20 using SIP via the LAN 10. The integrated media group communications server 12 is also connected to the Internet 40 through the LAN 10 and the firewall/router 28/30. Both cell and WiFi communications are routed through the integrated media group communications server 12 to establish group communications, and any device to which the server 12 has access, including PBX phones, can be a member of a group. As used herein, a member, or participant, in a group communication is a communication device, an application program (e.g. CRM, salesforce, or inventory control application programs), or objects with which the system can communicate electronically (i.e. bells, lights, alarm systems, etc.).

The directory services server 24, presence server 26 and media server 34 are all accessible to the integrated media group communications server 12 via LAN 10. The directory services server 24 can, for example, use Lightweight Directory Access Protocol (LDAP) to communicate with the integrated media group communications server 12. The presence server 26 can, for example, use SIP Instant Messaging and Presence Leveraging Extensions (SIMPLE) to communicate with the integrated media group communications server 12. SIMPLE can carry presence information, conveying a user's willingness and ability to engage in communications. The media server 34 can, for example, use SIP to communicate, and is connected to the PSTN gateway 32, the integrated media group communications server 12 and SIP servers 20 via the LAN 10. The media server 34 provides interactive voice response (IVR) and conferencing functionality. Media servers, or gateways, typically offer conferencing functionality, play and record functionality, speech recognition, and text-to-speech translation.

Wireless mobile communication devices, such as 2.5 G cellular devices, WiFi devices and dual mode GSM and CDMA devices can connect to the enterprise system. Dual mode devices, such as illustrated dual mode device 42, provide dual-mode connectivity to both the base station network 22 via WiFi, and the cell phone network 44 via GSM or CDMA. The cell network 44 connects to the PSTN 46 and the Internet 40. Voice calls from the dual mode device 42, or other cellular device 43, can travel from the cell network to the PSTN via trunk or digital lines, and data packets can travel from the cell network to the Internet. WiFi devices in range can communicate directly with base station network 22. External voice telephones 48 can also connect to the PSTN 46 via trunk or digital lines, and hence to the enterprise system.

Basic call flow and handoff using the above-described system architecture, and the extension of services to dual mode and cellular devices, is described in detail in U.S. patent application Ser. No. 11/422,173, filed Jun. 5, 2006, which is incorporated herein by reference in its entirety. Using the system, SIP services can be extended into a cellular network. As shown in FIG. 1, the system has access to both data and voice networks. The data network can include one or more LANs connected to a Wide Area Network (WAN). The voice network can communicate over both traditional circuit switched nodes and Voice Over IP (VOIP) nodes, which utilize the data network. The voice network can span both the enterprise domain and the public domain. Devices and boxes connected to the data network, such as phones, servers, gateways, base stations, desktops, and VOIP devices, typically store a unique network address, such as an IP address, in memory. Data packets can be routed to the device at the stored address. Devices connected to the circuit switched voice network use standard telephony addressing, such as telephone numbers or extensions. They are connected with standard interfaces, such as T1 trunks and digital lines.

The integrated media group communication server 12 provides two main functions. Based on a trigger, software running on the integrated media group communication server 12 can select a group (pre-programmed or created on-the-fly); select a media type (e.g. voice, video, IM, fax, email); select the style of group communication; select when the group communication should occur, including policy and presence-based timing; and, optionally, select an appropriate initial message to broadcast to the group. The trigger that initiates the group communication can be one of, but is not limited to, an alarm being raised in the system; a person calling a pre-programmed number and hanging up; detection of a relay being opened or closed; or a user selection of a group communication to be done later based on a policy.

The second main function provided by the integrated media group communication server 12 is to receive requests for a group communication and to cause them to happen at an appropriate time. The style of group communication can be one of, but is not limited to, a conference communication; a serial communication; a broadcast message; and a broadcast. A group communication can be schedule to happen immediately, when the members of the group are available, based, for example, on presence, or based on any other policy that can be defined. Groups can be pre-programmed and stored in the system; created on-the-fly by a user or administrator using directory entries, contacts and buddy lists; created on-the-fly by the system or a user, by, for example, selecting or filtering group members according to attributes stored in a database; created on-the-fly by the system when a group of users in an IM session wishes to change media to a voice session; created on-the-fly by users having devices with proximity detectors (i.e. ‘toothing’); or created on-the-fly when a user subscribes to a particular service. The concept of proximity can also be used in conjunction with devices provided with Global Positioning Satellite (GPS), or other location detection, functionality. For example all devices within a certain distance of a particular location could be triggered by, for example, a 911 attendant.

The integrated media group communication server 12, or servers attached to it, also, preferably, manages conversations, personalities, applications, media, billing, logging, features, groups, group features, phone-to-desktop conversation association, and organizational policies for groups, features, routing, etc. For example, a user can have multiple personalities, such as ‘personal’, and ‘business’ pre-programmed into the system. The currently active personality will determine the features, applications and services presented to the user, and can determine how communications are to be billed. For example, a ‘personal’ personality may determine that only cell mode should be activated, that media should be limited to voice and IM, that the displayed pre-programmed groups are limited to family, friends and community associations, that billing is to a home account, and the applications, such as personal banking should be made available. By contrast, a ‘business’ personality could determine that both cell and WiFi modes can be accessed, that voice, text, email and video communications are possible, that the displayed pre-programmed groups are work groups, buddy lists and professional associations, that billing is to a business account, and that applications, such as timesheets, should be available. A personality could be selected by the user on device power up, or could be invoked by various policies. For example, at certain times of the day or week (i.e. business hours), the user's personality can be set to ‘business’.

Due to the centralized management of group communications, group members can be notified and informed in a rich way. Participants can be notified who started the communication, who the participants are, and what the context or media type is (e.g. via a text/voice message). Participants can choose to accept, reject or defer the communication. The initiator of the communication can get information on who declined and who defered, and has the ability to re-invite these participants with an additional text/voice message.

The server 12 can also enable and manage conversations across multiple media types. As used herein, a conversation is a series of communications within an initial context that can span different media types. For example, a user can receive a voice call, switch to an IM session to ask a question related to the call, conference a number of parties together, and finally invoke a customer relationship management (CRM) application. Since all these services and features are centrally managed and deployed by the integrated media group communications server 12, the various communications can be billed and logged as a single occurrence. If the user is operating under a particular pre-defined personality, the media types, billing and logging options can be precisely defined. In addition, text-to-speech (TTS) synthesis applications can be used to convert text to speech, thereby permitting mixed media communications. For example, text responses in an IM environment can be converted to speech for a user on a cellular call.

The server 12 can also manage policies governing groups and their availability. Presence can be extended so that a user can see ‘group’ presence rather than individual presence. Individuals may be prevented from going unavailable if they are the last person available in a particular group. People can also have role-based presence, not just individual presence, so they can be available for a certain role defined by belonging to a group or according to a particular personality.

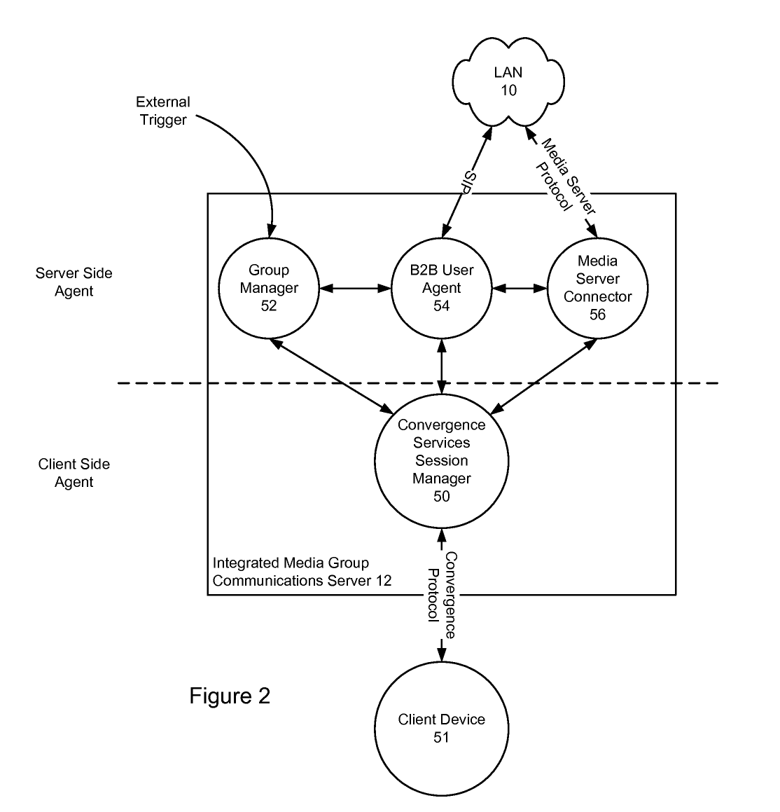

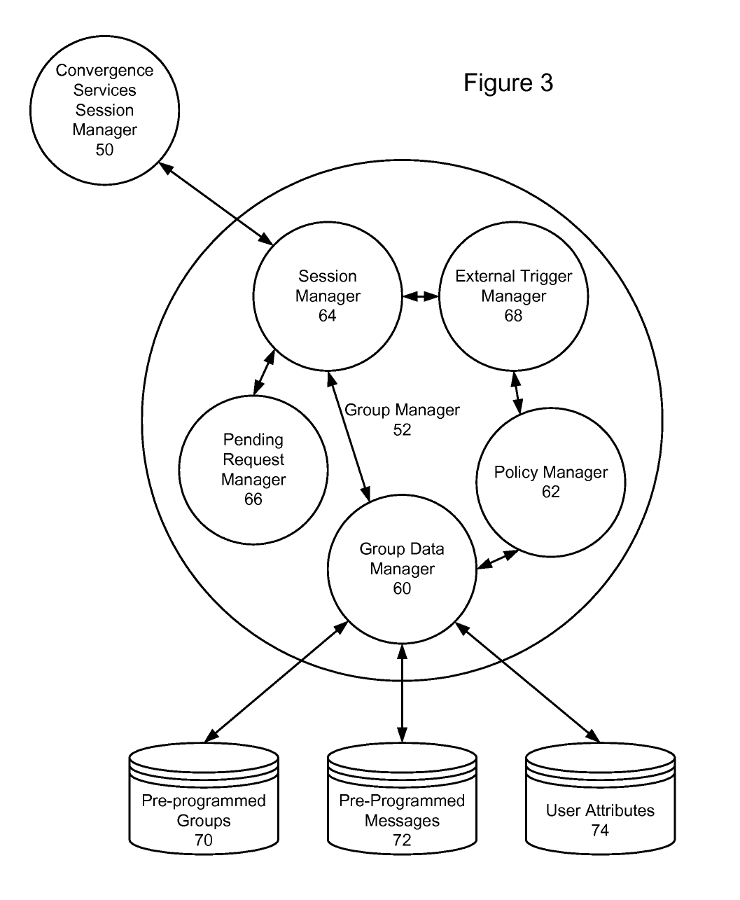

FIGS. 2 and 3 show an embodiment of internal functional modules within the server 12. The modules can be provided as firmware or software running on a processor in the server, in an operating system such as Linux or Windows. Each block identified can be implemented as a software agent that can exchange information with other agents in standard ways such as by messaging, invoking external procedures, sharing memory access, etc. The term “agent” describes a software abstraction, an idea, or a concept, similar to object-oriented programming terms such as methods, functions, and objects. An agent is a complex software entity that is capable of acting with a certain degree of autonomy in order to accomplish tasks. Unlike objects, which are defined in terms of methods and attributes, an agent is defined in terms of its behavior. Intelligent agents are able to adapt and to learn. Adaptation implies sensing the environment and reconfiguring in response. This can be achieved through the choice of alternative problem-solving-rules or algorithms, or through the discovery of problem solving strategies. Adaptation can also include other aspects of an agent's internal construction, such as recruiting processor or storage resources. Learning can proceed through trial and error, where previous behaviours and results are analyzed, or can proceed by example and generalization, which implies a capacity to abstract and generalize.

Referring to FIG. 2, the integrated media group communications server 12 comprises a server side and a client side, implemented as intelligent server and client agents, respectively. The client side comprises a convergence services session manager 50, while, in one embodiment, the server side comprises a group manager 52, a back-back (B2B) user agent 54 and a media server connector 56. The convergence services session manager 50 manages communications with client devices 51 using a convergence protocol. The client devices 51 can be any mobile communication device, such as cell, dual mode and SIP phones. The convergence protocol is a proprietary HTML-based protocol, that reduces the messaging required between the convergence services session manager 50 and any connected client device. In a presently preferred embodiment, the client device sends periodic HTML_GET messages to the convergence services session manager 50. If an event directed to the client device, such as an incoming call, an IM request or the detection of a desired presence, is received during a given period, the convergence services session manager 50 sends an HTML_OK message, with the event information, to the client device. If no event is detected during a given period, the convergence services session manager returns an empty HTML_OK message to the client device at the expiry of the period.

The convergence services session manager 50 receives and sends convergence protocol messages; translates to and from the convergence protocol to SIP, LDAP or suitable proprietary protocol; manages the various sessions between all mobile wireless devices; manages connections to the B2B user agent 54; manages policies related to users using mobile wireless devices; keeps the data connections with the mobile wireless devices alive; and manages security issues. In addition, the convergence services session manager 50 can receive out-of-dialog Instant Messaging (IM) messages from a WiFi device, or from a dual mode phone when in WiFi mode, to handle group communications. The convergence services session manager 50 communicates with the media server 34 via the media server connector 56. It does this using an appropriate media server protocol. The media server connector 56 will differ depending on the particular media server(s) in the system. The media server 34 can also be integrated directly within the integrated media group communications server 12, in which case it can be directly connected to the media server connector 56. In other embodiments of the system of the present invention, the server side agent can include other functional modules, such as an application connector. Such an application connector would communicate with the convergence services session manager 50 to permit communication with, for example, an application program, such as a CRM application, through an appropriate API.

The B2B user agent 54 registers at the PBX 14 on behalf of the mobile wireless device user(s), and acts as a SIP proxy agent to both ends of a SIP call. SIP proxy agents are well-known to those of skill in the art. The B2B user agent 54 is responsible for handling all SIP signaling between both ends of a call, from call establishment to termination. Each call is tracked from beginning to end, allowing the operators of the server 12 to offer value-added in-call features. The server 12 generally acts as a unified and integrated interface between the client device and the provider of the services or features. For example, conferencing functionality is generally provided by the media server 34. By extending this concept, all calls that want in-call features can be created as pseudo two-party conferences, with added functionality. In the case of a normal incoming or outgoing call, instead of using SIP Redirect or Refer functionality, two SIP calls are set up, both terminating on the B2B user agent 54. When a Class A cellular telephone is used, both a voice and data channel can be available as separate sessions, and a relationship between the voice and data session is maintained by the intelligent client side and server side agents. This also applies to the case where there are two devices involved: one to handle the voice and the other to handle the data. When a user decides to make a call, he can specify the device on which he wishes the voice call to be established. If he chooses a different device than the one originating the request, he can choose to manage the voice call through a data channel to the originating device. For example, a personal digital assistant (PDA) could be used to set up a call and a SIP phone 36 could be the target voice device. Once the voice call is established, the PDA can be used to manage features for that voice call.

The group manager 52 receives all group communication requests and is responsible for managing them. It can also receive external triggers that can cause system initiated group communications. It uses the convergence services session manager 50 to set up appropriate communications, either using the media server 34, or a SIP user agent as described in U.S. patent application Ser. No. 11/422,173. The externally triggered requests can take numerous forms, including external alarms, conditions set in another application available through an API, or responses to detected conditions, such as a physical contact closure (i.e. door opening or closing).

While the functionality of the present invention is provided by the integrated media group communication server 12, the client devices must have access to appropriate application software or firmware to access the group communication functions set out herein, and to create appropriate group communication request messages. An appropriate convergence services agent can run on a mobile communication device, a SIP softphone, a personal computer connected to the LAN 10, a wireless dual mode device 42, or any device that is connected to the LAN that is capable of handling this functionality. The convergence services agent preferably allows a user to select a group (pre-programmed or created on-the-fly); select a media type (e.g. voice, video, IM, fax, email); select the style of group communication; select when the group communication should occur, including policy and presence based timing; select the device from which the communication should be initiated; and, optionally, select an appropriate initial message to broadcast to the group. According to an embodiment, the application software can include a number of functional modules. A display module permits a user to select or set up a group communication. A control module can be provided to keep groups, contacts, buddy lists and directories up-to-date by communicating with the integrated media group communications server 12 through appropriate dispatch and receive modules using the convergence protocol. The display module permits the user to select the group, the media type (voice, IM, etc.), the style of communication, the invoking device, the initial message to be given to the members, and the policy governing when it should occur. It then gives this information to the module, which in turn creates a message using the convergence protocol and sends it to the integrated media group communications server 12 through the dispatch and receive modules. After this point, normal communication handling is used to communication with the appropriate devices.

The group manager 52 is shown in greater detail in FIG. 3, and comprises a group data manager 60, a policy manager 62, a session manager 64, a pending request manager 66 and an external trigger manager 68. The group manager 52 is responsible for receiving group requests, either from a client, or from an external trigger, determining the appropriate group members, managing the communication until termination, and queuing up pending requests and invoking them at the appropriate time. The group manager 52 uses the convergence services session manager 50 to accomplish the actual communications with the client device. For client requests the information for the sessions is received in a message from the client device. For system triggered requests, such as an alarm status, the policy manager 62 determines the information.

The session manager 64 receives requests for group communications from the convergence services session manager 50. The session manager 64 creates a new session to manage this communication. This session contains all pertinent information about the communication, including the group, which is identified using the group data manager 60, the media type (voice, video, IM, etc.), style of communication, the invoking device where appropriate, the initial message to be given to the members where appropriate, and the policy governing when the initial message should occur. If the request is immediate, the session is passed to the convergence services session manager 50, which has the B2B user agent 54 set up a call with the initiating device, or passes the session to the media server 34 via the media server connector 56, in which case, the media server invokes the call(s).

If the request is not immediate, then the session manager 64 passes the session to the pending request manager 66, which keeps the session queued until the appropriate time. To do this it may need to ask for information from the convergence services session manager 50, such as, for example, presence information.

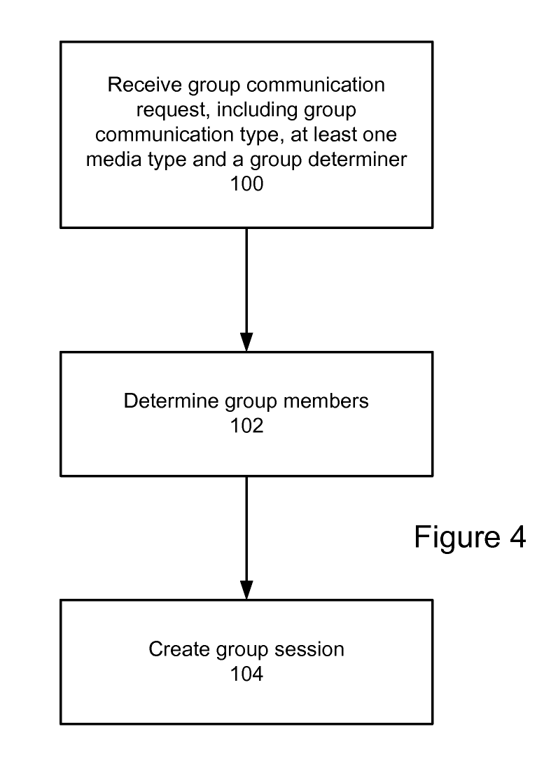

Operation of the system will now be described in relation to several exemplary scenarios. The scenarios represent specific instances of communications, but where a voice communication is described, an IM communication could work in a similar manner. Generally, as shown in FIG. 4, the method of managing a multimedia group communication of the present invention comprises receiving a group communication request (100). The group communication request includes a group communication type, at least one media type and a group determiner. Group members associated with the group communication request are then determined (102), and a group session, including the determined group members and the at least one media type, is created (104).

The first scenario describes the set up of an immediate conference communication from a wireless client using a pre-programmed group and employing a PBX phone. Referring to FIG. 2, the convergence services session manager 50 receives a request, over the convergence protocol, to set up a voice conference communication with a specified pre-programmed group. A PBX phone address is the device it wishes to initiate the conference from. It passes this request to the group manager 52. Referring to FIG. 3, the session manager 64 receives the request from the convergence services session manager 50. The session manager 64 creates a new session for the desired communication, consults the group data manager 60 to retrieve the members of the pre-programmed group from pre-programmed group database 70, and then asks the convergence services session manager 50 to invoke a voice conference with the pre-programmed group members and the specified device as the initiator. The session is passed through the media server connector 56 to the media server 34, which creates the conference appropriately. The media server 34 can, for example, be a SIP conferencing server, such as provided by 3Com Corporation.

In a second scenario, a serial voice communication is initiated by a wireless client using an on-the-fly group. A serial call is a feature offered by PBXs where a series of calls are executed in order without requiring the user to redial into the PBX between calls. Generally, a user calls an attendant, which tags the call as a serial call, and transfers the caller away. When the party the user is talking to hangs up, the call comes back to the attendant, and the user can specify a new party. This feature is especially useful for cell phone users who do not want to keep dialing the same number to reach a number of people. With the B2B user agent 54, and the media server 34, this functionality can be automated and made even more useful.

In this case, the user selects a list of parties he wishes to talk to from a buddy list, contacts, or from the company directory, as he would in a conference. However, instead of invoking a conference call, the user invokes a voice serial call. Referring to FIGS. 2 and 3, the convergence services agent running on the client device conveys the serial call request along with the list of users, using the convergence protocol, to the convergence services session manager 50. The convergence services session manager 50 then passes the request to the group manager 52. The group manager 52 creates a new session using session manager 64, then selects the first member on the list and has the B2B user agent 54 set up a call in the normal fashion.

When the B2B user agent 54 is disconnected from the called party, either through a hang up or a call transfer, it keeps the cell call up and goes back to the group manager 52 to determine a next action. The group manager 52 can optionally use a Play function to inform the mobile device user that the next call will be tried, and then ask the B2B user agent 54 to set up a new call. Optionally, the group manager 52 could wait for the user to input a DTMF response to skip this party, or come back to them later. This process is repeated until the end of the list is reached. The group manager 52 then queries the user, such as by using the Play function, whether he would like to input a new number, or disconnect. If the user enters a new number, then a new call is made just like the other calls. If not, the call is disconnected.

At any point, the B2B user agent 54 may receive busy, reorder, voice mail or no answer signals. These signals can be relayed to the user, who can be given an option of skipping to the next call or invoking any other in-call feature. For example, if the user selects a Go to Next feature, the convergence services agent can then use pre-stored data to cause the cell phone to outpulse a particular DTMF stream. The PSTN gateway 32 will receive these DTMF digits and convert them into SIP DTMF messages. The PSTN gateway 32 then sends these to the B2B user agent 54. The B2B user agent 54 receives these DTMF messages and uses digit conversion functionality provided by the media server 34 to convert them into the correct function. In this case, it is not a PBX feature, so it drops the current call and returns control to the group manager 52, which then continues to the next member on the list.

In a further scenario, a broadcast IM message communication is created by an external trigger using an on-the-fly group created by the system and a pre-programmed message. Referring to FIG. 3, the external trigger manager 68 receives an external trigger, such as an alarm. The external trigger manager 68 consults the policy manager 62 to determine the communication parameters for this trigger. The policy manager 62 determines that the group is defined by selecting members from a database based on a particular field or attribute. For example, all employees belonging to an enterprise IT department could define the group. The policy manager 62 asks the group data manager 60 to provide the group members. The group data manager 60 filters an employee database 74 to determine the member list, which is passed back to the external trigger manager 68. The policy manager 62 also determines that a pre-programmed message is to be used, and instructs the group data manager 60 to retrieve the message from a pre-programmed messages database 72. The policy manager 62 then passes the request to the session manager 64, which creates a session for this communication with the passed parameters. The session manager 64 then passes the session to the convergence services session manager 50. The convergence services session manager 50 connects to the media server 34, through the media server connector 56, which sends the retrieved IM message to all the members of the group.

In a fourth scenario, a broadcast voice communication is sent from a client device to a pre-programmed group when all group members are available. Referring to FIGS. 2 and 3, the convergence services session manager 50 receives a request, over the convergence protocol, to set up a voice broadcast communication with a specified pre-programmed group. The convergence services session manager 50 passes the request to the group manager 52. The session manager 64 receives this request, and creates a new session for the communication. The session manager 64 and consults the group data manager 60 to retrieve the members of the pre-programmed group from the database 70. The session manager 64 then passes the request to the pending request manager 66, which monitors all the members of the group until they are all free. It does this by periodically querying the convergence services session manager 50 about the status of each member. The convergence services session manager 50 can, for example, use a proprietary connector to access a presence supplementary service.

When the pending request manager 66 decides that the request should be executed, it informs the session manager 64. The session manager 64 then uses the convergence services session manager 50 to inform the initiating device that the call can be begun. For example, the convergence services session manager 50 can send an IM message to the initiating device using the B2B user agent 54. If the user accepts the request, the session manager 64 is informed and it asks the convergence services session manager 50 to set up a voice call to the initiating device using the B2B user agent 54. When this call is answered, the session manager 64 is informed, and then makes simultaneous requests to the convergence services session manager 50 for calls to be made to every member of the group. A conference call can be set up, or, once one member of the group answers the call, the session manager 64 can terminate all the other requests and place the initiating device and the answering user in a voice call.

In the preceding description, for purposes of explanation, numerous details are set forth in order to provide a thorough understanding of the embodiments of the invention. However, it will be apparent to one skilled in the art that these specific details are not required in order to practice the invention. In other instances, well-known electrical structures and circuits are shown in block diagram form in order not to obscure the invention. For example, specific details are not provided as to whether the embodiments of the invention described herein are implemented as a software routine, hardware circuit, firmware, or a combination thereof.

Embodiments of the invention can be represented as a software product stored in a machine-readable medium (also referred to as a computer-readable medium, a processor-readable medium, or a computer usable medium having a computer-readable program code embodied therein). The machine-readable medium can be any suitable tangible medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention can also be stored on the machine-readable medium. Software running from the machine-readable medium can interface with circuitry to perform the described tasks.

The above-described embodiments of the present invention are intended to be examples only. Alterations, modifications and variations can be effected to the particular embodiments by those of skill in the art without departing from the scope of the invention, which is defined solely by the claims appended hereto.

What is claimed is:

1. A method of managing a multimedia group communication, comprising:
receiving a group communication request including a group communication type, at least one media type and a group determiner;
determining group members associated with the group communication request; and
creating a group session including the determined group members and the at least one media type.

2. The method of claim 1, further including logging and billing the group communication.

3. The method of claim 1, further including passing the group session to a media server to invoke the group communication.

4. The method of claim 1, wherein the group communication request is received from a client device.

5. The method of claim 4, wherein the client device is a wireless mobile communications device, a SIP device, or a personal computer.

6. The method of claim 5, wherein the wireless mobile communications device is a Class A cellular telephone, a Class B cellular telephone, or a dual mode device.

7. The method of claim 1, wherein the group communication type is a conference communication.

8. The method of claim 1, wherein the group communication type is a serial communication.

9. The method of claim 1, wherein the group determiner is an identification of a pre-programmed group, a user selection, a previously determined group, a policy, or a user attribute.

10. The method of claim 1, wherein determining the group members associated with the group communication request comprises invoking a policy.

11. The method of claim 1, wherein the group members include a physical device or an application program.

12. The method of claim 1, wherein the group determiner is a user attribute.

13. The method of claim 12, wherein the user attribute is presence, proximity, subscription to a topic, or availability.

14. The method of claim 13, wherein presence is role-based presence.

15. The method of claim 12, wherein determining the group members includes filtering on the user attribute.

16. The method of claim 1, wherein the group communication request is an externally triggered request.

17. The method of claim 16, wherein the externally triggered request is an alarm, a condition set in a communicating application program, or a detection of a physical condition.

18. The method of claim 16, wherein the externally triggered request invokes a policy.

19. The method of claim 1, wherein the group communication request further includes a pre-programmed message.

20. The method of claim 1, wherein the at least one media type is voice, video, instant messaging (IM), facsimile or email.

21. The method of claim 1, wherein the group communication is a conversation over multiple media types.

22. The method of claim 21, wherein the conversation occurs over multiple media types concurrently.

23. The method of claim 1, further including providing a rich feature set pertaining to the group communication.

24. The method of claim 23, wherein the rich feature set includes providing a listing of the group members.

25. The method of claim 24, wherein the listing includes invited participants who declined or deferred entry into the group communication.

26. The method of claim 23, wherein the rich feature set includes an option to present a forced re-invite to invited participants who declined or deferred entry.

27. The method of claim 26, wherein the forced re-invite includes a new message.

28. The method of claim 23, wherein presence of group members of a selected group is presented.

29. The method of claim 1, wherein a first client device receives the group communication, and a second client device controls the group communication.

30. A multimedia server for managing a group communication, comprising:
an intelligent client side agent to establish and manage the group communication; and
an intelligent server side agent having a group manager to receive a group communication request, to determine group members associated with the group communication request, and to create group sessions for the group communication, the group sessions including the group members and at least one media type.

31. The server of claim 30, wherein the at least one media type is voice, video, instant messaging (IM), facsimile or email.

32. The server of claim 31, wherein the intelligent client side agent includes a convergence services session manager, and the intelligent server side agent includes a back-to-back (B2B) user agent to set up the group sessions under the control of the convergence services session manager.

33. The server of claim 30, further including means for managing multiple personalities for a user.

34. The server of claim 30, further including means for defining each user's role-based presence, and displaying group presence information.
